(19) United States
(12) Patent Application Publication
(10) Pub. No.: US 2010/0053605 A1
(43) Pub. Date: Mar. 4, 2010

(54) GAS SAMPLING DEVICE AND METHOD FOR COLLECTION AND IN-SITU SPECTROSCOPIC INTERROGATION OF VAPORS AND AEROSOLS

(75) Inventors: Anthony J. Ragucci, Bryan, TX (US); Bikas Vaidya, College Station, TX (US); Ashwin Kumar Balasubramanian, College Station, TX (US); Mark J. Flusche, College Station, TX (US)

Correspondence Address: STREETS & STEELE, 13100 WORTHAM CENTER DRIVE, SUITE 245, HOUSTON, TX, 77065, US

(73) Assignee: LYNNTECH, INC., College Station, TX (US)

(21) Appl. No.: 12/508,721

(22) Filed: Jul. 24, 2009

Related U.S. Application Data
(60) Provisional application No. 61/083,719, filed on Jul. 25, 2008.

(51) Int. Cl. G01J 3/44; G01N 1/22

(52) U.S. Cl. 356/301; 73/863.21

(57) ABSTRACT

A gas sampling device, analyte detection system, and methods for identifying a vapor or aerosol analyte suspended in a gas are described. The gas sampling device comprises a chamber having a gas inlet port, a substrate, one or more gas outlet ports near the substrate, and a pump. The gas outlet ports direct airflow to a reflecting substrate coated with a spectroscopically-transparent material. Analytes are deposited on the coated substrate through impaction, for massive aerosols, and diffusion through the viscous boundary layer, for vapor analytes. In one analyte detection system, a spectroscopic instrument is positioned behind a window opposite the substrate to interrogate the coated substrate surface as analytes are collected. An alternate detection system combines the gas sampling device with a detector in fluid communication with the gas outlet ports from the chamber, wherein the substrate is used as an analyte concentrator.

### CROSS-REFERENCE TO RELATED APPLICATIONS

This application claims priority of U.S. provisional patent application Ser. No. 61/083,719 filed on Jul. 25, 2008,

### STATEMENT REGARDING FEDERALLY SPONSORED RESEARCH OR DEVELOPMENT

This invention was developed with funding under Contract No. FA9550-05-C-0104 awarded by the Air Force Office of Scientific Research and Contract Nos. W911SR-05-C-0046 and W911SR-08-C-0082 awarded by the US Army RDECOM Acquisition Center. The government may have rights in this invention.

### BACKGROUND OF THE INVENTION

1. Field of the Invention

The present invention relates to the sampling and identification of analytes, such as vapors and aerosols, present within a gas.

2. Background of the Related Art

There are many military, industrial and residential applications for sampling and identifying vapors and aerosols in air or other gases. One device used to obtain a vapor sample from a gas is a sorption tube. The sorption tube provides a gas passageway through the tube for contact with a bed of a sorbent material. A typical sorbent material, such as aluminum oxide, is porous to provide a high internal surface area for the absorption of vapor from the gas. Another device used to obtain a particular sample from a gas is an impactor air sampler. The impactor collects aerosols onto a substrate based on particulate inertia in the airflow. Particles with enough inertia to pass through the viscous boundary layer above a substrate impact the surface. In either method, after an analyte sample has been collected from the gas, it is still necessary to subsequently test the collection media in order to identify the analyte. These existing sample collection devices cannot measure analytes in real time as they are being collected.

U.S. Pat. No. 7,295,308 (Samuels) discloses a continuous monitoring method and system using a porous substrate of film which is designed to collect both vapors and aerosols. The air from the environment is drawn through a region of the porous substrate by an air pump and the substances in the air are deposited or chemically adsorbed onto the surface of the substrate. The region of the substrate where the environmental air is drawn through is continuously monitored by a spectrometric method. The substrate is in the form of a tape supplied by a feed reel in a reel-to-reel cartridge and taken up by a take-up reel as found in a film cartridge or a magnetic tape cartridge. An optical interrogation system is engineered such that the surface of the tape at the point where air from the environment is drawn through the substrate becomes the interrogation region for the spectrometer. As material from the environment accumulates in this region, the spectra from collected material is monitored by a suitable detector and supporting circuitry.

### BRIEF SUMMARY OF THE INVENTION

One embodiment of the present invention provides a gas sampling device. The gas sampling device comprises a chamber having one or more gas inlet ports, a substrate, and one or more gas outlet ports near the substrate; and a pump having a suction side coupled to the one or more gas outlet ports, wherein the one or more gas outlet ports directs the airflow towards an impermeable stationary substrate for collection and allows the substrate to be interrogated by a spectroscopic beam.

Another embodiment of the invention provides an analyte detection system. The analyte detection system comprises the gas sampling device and a detector in fluid communication with a gas outlet port from the chamber, wherein the substrate is used as an analyte concentrator. Optionally, the system may include a heater disposed in thermal communication with the substrate to rapidly release collected analyte from the substrate surface for delivery to the detector. The detector may, for example, be selected from the group consisting of an ion mobility spectrometer, differential ion mobility spectrometer, gas chromatograph, gas chromatograph-mass spectrometer, gas chromatograph-electron capture detector, gas chromatograph-flame ionization detector, gas chromatograph-infrared detector, gas chromatograph-Fourier-transform infrared detector, and gas chromatograph-nuclear magnetic resonance detector.

Yet another embodiment of the invention provides an analyte detection system with an integral detector. The analyte detection system comprises the gas sampling device and a spectrometer directly across the chamber from the substrate surface, wherein the substrate is reflective and coated with a high-surface-area (e.g. more than 10 m²/g), spectroscopically transparent material. Optionally, the distance between the spectrometer and the substrate is adjustable. The substrate under interrogation may be replaced as needed, should collected analytes or any collected interferant materials unacceptably reduce the reflected intensity of the spectroscopy beam in one or more spectral bands. Alternately, such collected materials may be desorbed through heating of the substrate, enabling continued operation of the device with the same substrate.

### BRIEF DESCRIPTION OF THE SEVERAL VIEWS OF THE DRAWINGS

FIG. 1 is a schematic diagram of an analyte collection and identification system.

FIG. 2 is a cross-sectional side view of a gas sampling device.

FIG. 3 is a schematic diagram of another analyte collection and identification system employing cross-flow, only, configured for a reflective substrate.

FIG. 4 is a schematic diagram of another analyte collection and identification system configured for a transmissive substrate.

### DETAILED DESCRIPTION OF THE INVENTION

One embodiment of the present invention provides a gas sampling device. The gas sampling device comprises a chamber having one or more gas inlet ports, a substrate, and one or more gas outlet ports near the substrate; and a pump having a suction side coupled to the one or more gas outlet ports, wherein the gas inlet port directs the airflow to impinge upon the substrate in such a manner that both vapors and aerosols are collected while the substrate is monitored spectroscopically by an electromagnetic beam which focuses onto and reflects off of the substrate. Monitoring may be performed on-demand, in response to a trigger, periodically, or continuously. The method is preferably performed with an integral spectrometer so that the analyte may be identified without removing the substrate from the chamber and without removing the analyte from the substrate.

Embodiments of the present invention allow the collection of airborne vapor and aerosol analytes onto a substrate for continuous spectral analysis in such a way that the product of volumetric flow rate and pressure differential required to draw air through the gas sampling device is lower than would be required for similar capture efficiency of vapor and aerosol analytes using filter media. Additionally, the substrate presents a uniform, solid reflecting surface for spectroscopic interrogation of the collected analytes. The gas sampling device design enables vapor and aerosol analyte collection from a gas without the need for excessive pump power.

Without limiting the scope of the invention, it is believed that an analyte in the gas may be collected on the substrate in one of two ways. Massive aerosols may be collected by penetrating the viscous boundary layer above the substrate and impacting the substrate surface due to their inertia in the airflow. Vapors may be brought into close proximity with the substrate, where they can diffuse across the viscous boundary layer above the substrate to contact the substrate surface.

Optionally, the gas outlet port may be a restriction directly in front of the central region of the substrate, with a guide cone to direct the airflow towards the center of the substrate. The back side of the cone may be geometrically relieved in order to minimize flow impedance in the air path after passing the central region of the substrate.

The gas sampling device may further comprise a removable cap for selectively securing the substrate within the chamber. The removable cap may also secure a spring, such as a wave spring, between the cap and the substrate in order to bias the substrate into a secured operable position within the chamber. Furthermore, the removable cap may include an exhaust port for withdrawing the cumulative gas flow from each of the one or more gas outlet ports. Optionally, the removable cap may hold the substrate in place using clips which hold the substrate against a backing surface.

The surfaces of the gas inlet port and chamber walls should be made of a material that is resistant to absorption of the analyte or reaction with the analyte. A preferred material is stainless steel, such as 316 stainless steel. Using a material that will not react with or absorb the analyte prevents partial or complete loss of the analyte in a single use of the device, and may prevent analyte carryover between multiple uses of the device. Additionally, surface treatments such as electropolishing and silicon-based coatings such as SULFINERT (available from Restek Corporation of Bellefonte, Pa.) or SILCOSTEEL (available from SilcoTek Corporation of Bellefonte, Pa.) or SILONITE (available from Entech Instruments, Inc. of Simi Valley, Calif.) can reduce undesirable adsorption of analyte onto the walls of the gas sampling device.

In another embodiment, the substrate may be either spectroscopically transparent or reflective with a coating of a spectroscopically transparent material in order to be used in combination with a spectroscope for identifying the analyte. Preferred substrates for spectroscopic detection are described in U.S. patent application Ser. No. 11/768,040 filed on Jun. 25, 2007, which application is incorporated by reference herein in its entirety.

In yet another embodiment, the substrate coating may be a material that concentrates the analyte, yet will desorb the analyte rapidly when heated. Non-limiting examples of a concentrator material include silica gel, charcoal, CHROMOSORB 103, PORAPAK P and R, XAD resin, THERMOSORB, CARBOPACK B and TENAX GC.

Another embodiment of the invention provides an analyte detection system. The analyte detection system comprises the gas sampling device and a detector in fluid communication with a gas outlet port from the chamber, wherein the substrate is used as an analyte concentrator. Optionally, the system may include a heater disposed in thermal communication with the substrate to rapidly release material from the substrate surface for delivery to the detector. The detector may, for example, be selected from the group consisting of an ion mobility spectrometer, gas chromatograph, gas chromatograph-mass spectrometer, gas chromatograph-electron capture detector, gas chromatograph-flame ionization detector, gas chromatograph-infrared detector, gas chromatograph-Fourier-transform infrared detector, and gas chromatograph-nuclear magnetic resonance detector.

Yet another embodiment of the invention provides an analyte detection system with an integral detector. The analyte detection system comprises the gas sampling device and a spectrometer directly across the chamber from the substrate surface, wherein the substrate is spectroscopically transparent or coated with a spectroscopically transparent material. Optionally, the distance between the spectrometer and the substrate is adjustable. It is preferable to orient the substrate substantially perpendicular to a central axis of the spectrometer. In various embodiments, the substrate and the spectrometer enable Surface-Enhanced Raman spectroscopy, Fourier-transform infrared spectroscopy or infrared absorption spectroscopy. Preferred substrates for spectroscopic detection are described in U.S. patent application Ser. No. 11/768,040 filed on Jun. 25, 2007, which application is incorporated by reference herein in its entirety. One non-limiting example of a suitable substrate is a disk having a diameter of about 0.75 inches.

A further embodiment of the invention provides a method of identifying an analyte suspended in a gas. The method generally comprises flowing the gas through a chamber, directing the gas flow towards a surface of an impermeable substrate, collecting and concentrating the analyte on the substrate surface; and analyzing the analyte in contact with the substrate using a spectrometer.

The step of flowing the gas into the chamber preferably includes running a pump having a suction side coupled to an exhaust port leading from the chamber. A non-limiting example of a suitable pump is an inspection-grade gas sampling pump that is continuously adjustable between 5 and 5,000 ml/min and compensates for flow impedance changes to maintain a set flow rate within 5%. Optionally, the pump may be battery-powered, lightweight and small in order to provide user portability of the analyte sampling device or the analyte detection system. Higher flowrates may also be employed, such as 20,000 ml/min, in order to increase the rate of analyte introduction into the system. Tubing suitable for coupling the pump to the exhaust port includes, without limitation, polyvinyl chloride, polypropylene, or stainless steel tubing.

In an alternate embodiment, a nozzle immediately in front of the substrate may increase airflow momentum and subsequently drive aerosols towards the substrate and reduce the viscous boundary layer thickness above the substrate so that the rate of vapor analyte diffusion to the substrate is increased. In this configuration, the airflow is directed towards the center of the substrate, where an infrared beam would interrogate the substrate surface.

In a still further embodiment, the gas is air and the analyte is either a vapor or a particulate. Optionally, the analyte is a chemical or biological warfare agent.

Various embodiments of the invention are able to sample a mixture of analytes, such as a vapor and an aerosol (solid or liquid particulate). Once a sample has been collected, the analyte may be identified directly on the substrate using an optical detector. Another benefit of the sampling chamber is that the impedance to air flow is much lower through the chamber than through a sorbent tube.

FIG. 1 is a system diagram of an analyte collection and identification system 60. A gas sampling device 10 has an exhaust port 16 fluidically coupled to a pump 62 that draws a gas, such as air, into the device 10 through a gas inlet port 14. The geometry of a nozzle cone 32 directs the gas flow to the substrate 40 and draws the gas across a spectroscopically transparent concentration material 41 on the substrate surface. The analyte that has been deposited on the concentration material 41 may be analyzed by a spectroscopic interrogation device 64, such as a spectrometer, in real time as the pump is running. The spectroscopic interrogation device 64 provides a beam that passes through an IR-transparent window 65 and reflects off the substrate back to the device.

Optionally, the pump 62 and the spectrometer 64 may be operated by one or more controllers 66. Alternatively, the gas sampling device 10 and pump 62 may be used for analyte collection, then the device may be transported to a separate facility for analysis by the spectrometer 64. The controller 66 collects data from the spectrometer and processes the data to provide a useful output, such as a display on a graphical user interface 68. Optionally, the response measured by the spectrometer is compared against a database of empirical data in order to identify the composition of one or more analyte deposited on the substrate 40.

FIG. 2 is a cross-sectional side view of a gas sampling device 10 in accordance with an exemplary embodiment of the invention. The device includes a cylindrical body 12 that secures a gas inlet port 14 and an exhaust port 16 in communication with a central chamber 42. A nozzle cone 32 directs the airflow towards a reflective substrate 40 which may collect vapor and aerosol analytes onto a spectroscopically transparent concentration material 41 coated on the surface. The nozzle cone 32 is positioned opposite a window 30 such that a spectroscopic beam could traverse the window 30, pass through the concentration material 41, reflect off the substrate 40, pass back through the concentration material 41, thereby passing through the concentration material twice, and return to the spectroscopic instrument through the same window 30. The nozzle cone is also configured so that it does not interfere with the incoming or outgoing spectroscopic beam.

The gas sampling device 10 includes a nozzle cone 32 disposed fluidically between the inlet port 14 and exhaust port 16, and just upstream of the reflective substrate 40. The nozzle cone 32 is positioned directly in front of the reflective substrate with a central aperture that directs the flowing gas at the concentration material 41 on the reflective substrate 40. The distance from the nozzle cone aperture to the substrate 40 and the size and shape of the aperture may define both the analyte collection efficiency and the pressure differential through the gas sampling device. Therefore, the nozzle cone 32 may be part of a replaceable insert 34 within the body of the gas sampling device, so that multiple nozzle geometries can be used. Nozzle cones with apertures that focus the gas stream more tightly and are positioned closer to the substrate may cause higher analyte collection efficiency and faster response times in the instrument, but they will also cause higher flow impedance through the gas sampling device. Conversely, nozzle cones with apertures that are more open or positioned farther away from the substrate will require less pump power to draw gas through the gas sampling device.

The substrate may be held parallel to and a set distance from the window 30 so that the spectroscopic beam may focus directly on the substrate surface. After the gas flow interacts with the concentration material 41, the gas can vent into an open exhaust chamber within the body 12 and vent around the substrate into the exhaust port 16. Preferably, the entire flow path within the gas sampling device is sealed to protect the surrounding instrumentation, such as the spectrometer. This may be accomplished by using an O-ring 36 at the interface between the window 30 and the gas sampler body 12 and an O-ring 44 between the sample holder 38 and the gas sampler body 12. A threaded, removable cap 46 holds the sample holder in place and places pressure on the O-ring 44 to maintain a vapor-tight seal on the body 12 of the gas sampling device.

FIG. 3 is a generalized gas sampling device 70 embodying the invention in a cross-flow configuration. In this embodiment, the device 70 includes a body 72 that defines an air flow path (as indicated by the arrows) between the gas inlet port 14 and the gas outlet port 16. The cross-sectional area of the flow path is constrained at and around the spectroscopic measurement zone 74 in order to increase the airflow velocity above the concentration material 41 on the substrate 40 and, hence, locally reduce the flow boundary layer to enhance the analyte deposition rate. The spectroscopic interrogation instrument 64 provides a beam through the IR-transparent window 65, which reflects back to the instrument 64.

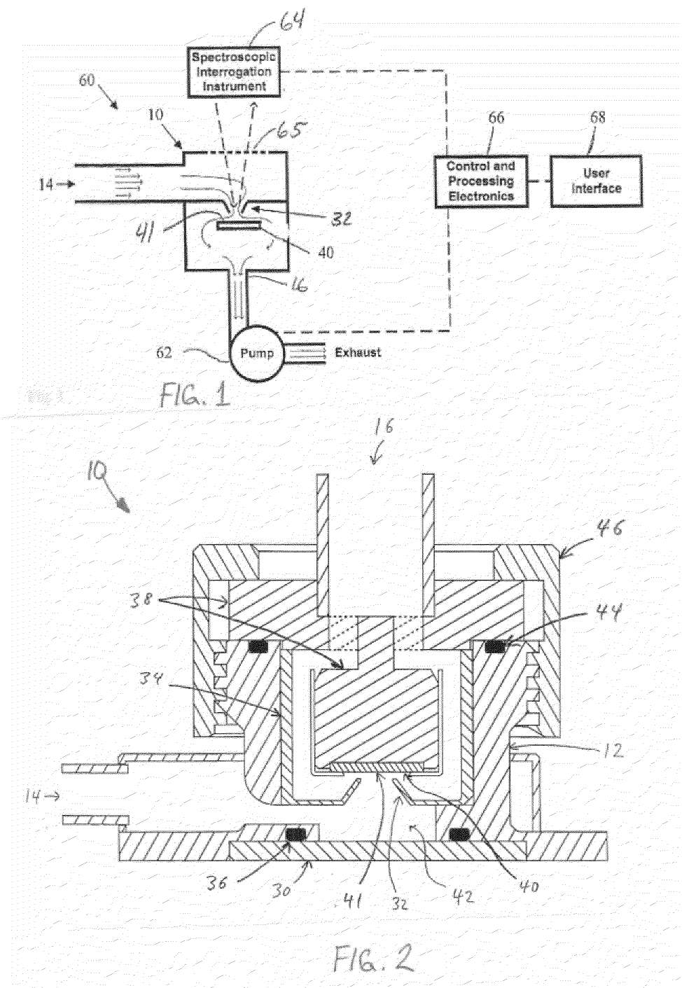

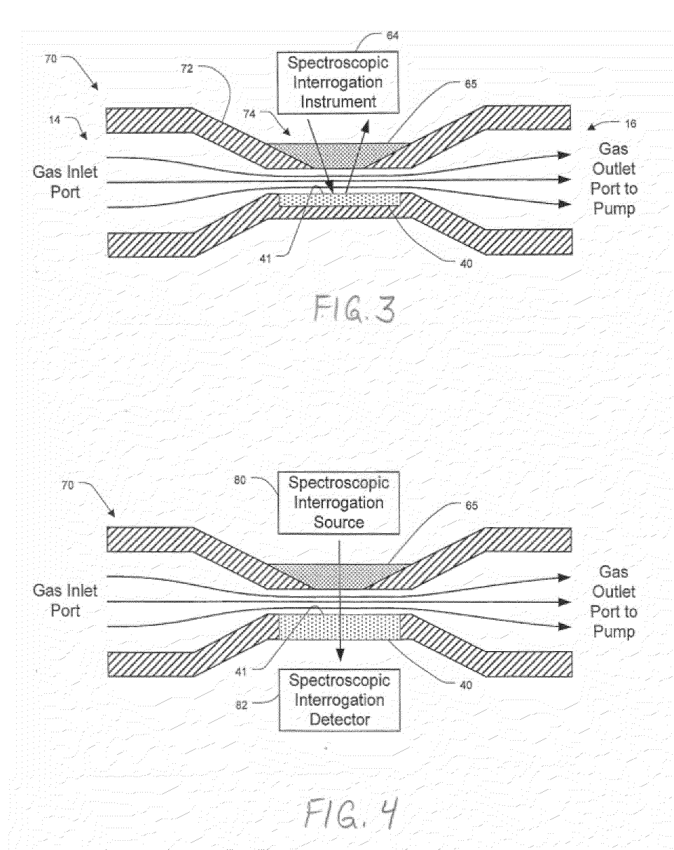

FIG. 4 is a alternate cross-flow configuration of the gas sampling device 70 in which the substrate 40 is spectroscopically transparent. The gas flow channel dimensions are identical to the configuration shown in FIG. 3, however the spectrometer source 80 and spectrometer detector 82 are located on opposite sides of the substrate. In this configuration, the source light may pass through an IR-transparent window 65, the concentration material 41, and the substrate 40 before being received by the detector 82.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A gas sampling device, comprising:
a chamber comprising one or more gas inlet ports, an impermeable reflecting substrate coated with a spectroscopically-transparent material, and one or more gas outlet ports near the substrate;
a pump having a suction side coupled to the one or more gas outlet ports, wherein gas flow through the one or more gas outlet ports directs the gas flow towards the substrate; and
a spectrometer disposed directly across the chamber from the substrate surface and directed at the substrate surface.

2. The device of claim 1, wherein the substrate includes an IR-transparent material selected from the group consisting of AgBr, AgCl, Al₂O₃ (sapphire), AsSeTe glass (chalcogenide), BaF₂, CaF₂, CdTe, CsI, diamond, GaAs, Ge, GeAsSe (AMTIR), MgF₂, KBr, KCl, KI, LiF, MgO, NaCl, Si, SiO₂ (quartz), SrF₂, TlBr—TlI (KRS-5), ZnS, ZnSe, ZrO₂, borosilicate glass, polyethylene, polyisobutylene, fluoropolymers, and combinations thereof.

3. The device of claim 2, wherein the IR transparent material is a coating.

4. The device of claim 1, wherein the substrate is oriented substantially perpendicular to a central axis of the incoming or outgoing spectrometer beams.

5. The device of claim 1, wherein the gas inlet port is directed substantially perpendicular to the central axis.

6. The device of claim 1, further comprising:
a detector in fluid communication with the one or more gas outlet ports from the chamber, wherein the substrate is used as an analyte concentrator.

7. The device of claim 6, further comprising:
a heater disposed in thermal communication with the substrate to rapidly release material from the substrate surface.

8. The device of claim 7, wherein the detector is selected from the group consisting of an ion mobility spectrometer, differential ion mobility spectrometer, gas chromatograph, gas chromatograph-mass spectrometer, gas chromatograph-electron capture detector, gas chromatograph-flame ionization detector, gas chromatograph-infrared detector, gas chromatograph-Fourier-transform infrared detector, and gas chromatograph-nuclear magnetic resonance detector.

9. The device of claim 1, wherein the surfaces of the gas inlet port and chamber walls are made of a material that is resistant to reaction with or absorption of the analyte.

10. The device of claim 1, wherein the surfaces of the gas inlet port and the chamber walls are made of stainless steel treated with a silicon oxide-based coating.

11. The device of claim 1, wherein the substrate is spectroscopically transparent or coated with a spectroscopically transparent material.

12. The device of claim 1, wherein the substrate concentrates an analyte material above the concentration of the analyte material in the gas.

13. The device of claim 1, wherein the substrate and the spectrometer enable Surface-Enhanced Raman spectroscopy.

14. The device of claim 1, wherein the substrate and the spectrometer enable Fourier-transform infrared spectroscopy or infrared absorption spectroscopy.

15. The device of claim 1, further comprising:
a nozzle cone disposed fluidically between the inlet port and the exhaust port, and just upstream of the substrate.

16. The device of claim 15, wherein the nozzle cone is positioned directly in front of the substrate with a central aperture that directs the flowing gas at the spectroscopically-transparent material coated on the substrate.

17. The device of claim 16, wherein the spectrometer is positioned to pass a spectroscopic beam through the central aperture of the nozzle cone.

18. The device of claim 17, wherein the spectrometer is isolated from contact with the gas flow by a spectroscopically-transparent window.

19. The device of claim 16, wherein the nozzle cone is selectively replaceable within the body of the gas sampling device.

20. A method of identifying an analyte suspended in a gas, comprising:
flowing the gas through a chamber;
directing the gas flow towards a surface of an impermeable substrate;
collecting and concentrating the analyte on the substrate surface; and
analyzing the analyte in contact with the substrate using a spectrometer.

21. The method of claim 20, wherein the step of flowing the gas through the chamber includes running a pump having a suction side coupled to the one or more gas outlet ports of the chamber.

22. The method of claim 20, wherein the gas is air.

23. The method of claim 22, wherein the analyte is a vapor or an aerosol.

24. The method of claim 23, wherein the analyte is a chemical or biological warfare agent.

25. The method of claim 20, wherein gas flows into the chamber through a gas inlet port that also provides a viewport for spectroscopic interrogation of the substrate surface.
